(19) United States
(12) Patent Application Publication
(10) Pub. No.: US 2003/0093371 A1
(43) Pub. Date: May 15, 2003

(54) Systems and methods for making disbursements of real estate settlement funds

(76) Inventor: Linda Wilson, Berlin, NJ (US)

Correspondence Address: PRIEST & GOLDSTEIN PLLC, 5015 SOUTHPARK DRIVE, SUITE 230, DURHAM, NC, 27713-7736, US

(21) Appl. No.: 09/683,048

(22) Filed: Nov. 13, 2001

(51) Int. Cl. G06F 17/60

(52) U.S. Cl. 705/40

(57) ABSTRACT

Systems and techniques are described for the payment of a recipient and a sub-recipient. One approach includes using a server computer to receive and store from a recipient an amount of an expected total disbursement, an amount of a sub-recipient portion of the expected total disbursement, and an authorization to pay the sub-recipient portion directly to the sub-recipient. This approach may further include receiving from a sender a gross disbursement for payment to the recipient and determining whether the amount of the gross disbursement received from the sender matches the amount of the total disbursement expected by the recipient. If these two amounts match, a payment server is instructed to make a direct payment to the recipient of the expected total disbursement, less the amount of the sub-recipient portion. The payment server is also instructed to make a direct payment to the sub-recipient of the sub-recipient portion.

### BACKGROUND OF INVENTION

The present invention relates generally to improvements to systems and methods for disbursement of funds, and more particularly to advantageous aspects of systems and methods for making disbursements of real estate settlement funds.

Real estate closing agents commonly disburse settlement funds by preparing and mailing checks to recipient vendors and paid-upon-settlement companies. Sub-recipients employed by the recipient vendors and paid-upon-settlement companies receive their compensation at the next post-settlement pay period, which is typically biweekly. However, for a number of reasons, including cash flow, time value of money, and employee satisfaction, it is highly desirable to compress the amount of time between settlement and disbursement of funds to recipients and sub-recipients.

### SUMMARY OF INVENTION

These and other problems are addressed by the present invention, various aspects of which provide systems and methods for the speedy payment of a recipient and a sub-recipient. One method according to an aspect of the invention includes using a server computer to electronically receive and store from a recipient: (1) an amount of an expected total disbursement, (2) an amount of a sub-recipient portion of the expected total disbursement, and (3) an authorization to pay the sub-recipient portion directly to the sub-recipient. The method further includes receiving from a sender a gross disbursement for payment to the recipient and determining whether the amount of the gross disbursement matches the amount of the total disbursement expected by the recipient. If these two amounts match, a payment server is instructed to make a direct payment to the recipient of the expected total disbursement, less the amount of the sub-recipient portion. The payment server is also instructed to make a direct payment to the sub-recipient of the sub-recipient portion.

Additional features and advantages of the present invention will become apparent by reference to the following detailed description and accompanying drawings.

### BRIEF DESCRIPTION OF DRAWINGS

FIG. 1 shows a diagram of the cash flow at a typical real estate closing.

FIG. 2 shows a diagram of a system for payment of a recipient and a sub-recipient, according to an aspect of the present invention.

FIG. 3 shows a flowchart setting forth a method for payment of a recipient and a sub-recipient, according to a further aspect of the invention.

### DETAILED DESCRIPTION

As used herein, the term “vendor” refers to an entity that is engaged to perform services prior to a real estate settlement and that is paid whether or not the settlement occurs. Typical vendors include, for example, pest inspection firms, appraisal firms, surveyors, and the like.

As used herein, the term “paid-upon-settlement company” refers to an entity that performs services either at, or prior to, a real estate settlement, and that is paid only if the settlement occurs. Typical paid-upon-settlement companies include, for example, real estate brokerage agencies, lending institutions, insurance agencies, loan brokerage agencies, and the like.

As used herein, the term “recipient vendor” refers to a vendor that is paid at a real estate settlement. The term “recipient paid-upon-settlement company” refers to a paid-upon-settlement company that is paid at a real estate settlement. Recipient vendors and recipient paid-upon-settlement companies are generically referred to herein as “recipients.” As used herein, the term “sub-recipient” refers to a party employed by a recipient who performs services in connection with the settlement, and who is paid by the recipient out of funds received by the recipient at the settlement. The term “vendor sub-recipient” refers to a sub-recipient employed by a vendor. The term “paid-upon-settlement company sub-recipient” refers to a sub-recipient employed by a paid-upon-settlement company. Typical vendor sub-recipients include, for example, field appraisers, field pest inspectors, and the like. Typical paid-upon-settlement company sub-recipients include, for example, real estate agents, loan officers, insurance agents, loan brokers, and the like.

As used herein, the term “closing agent” refers to an entity such as an escrow company, title company, attorney, or the like, who disburses funds at a real estate settlement.

As used herein, the term “sender” refers generically to any entity, including a closing agent, who uses the Speed Pay™ system described herein to disburse funds to recipients and sub-recipients.

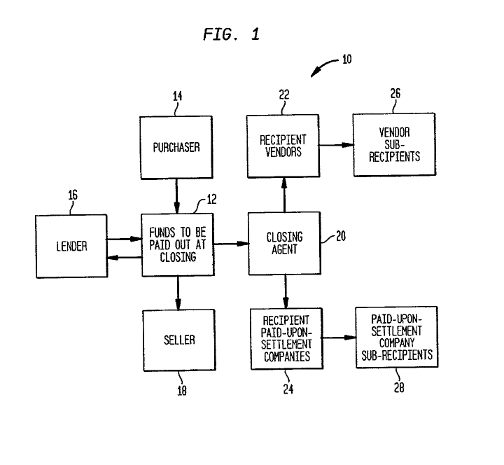

FIG. 1 shows a diagram of the cash flow 10 at a typical real estate closing. At closing, funds 12 have been accumulated that are to be paid out in order to complete the purchase transaction. The two primary sources of these funds are a purchaser 14, who typically contributes a down payment and other required payments and a lender 16, who contributes funds to be loaned to the purchaser 14. A portion of the funds 12 goes to a seller 18, who receives the agreed-upon purchase price of the property. Funds 12 are also paid to the lender. These payments can include points, loan servicing fees, mortgage insurance premiums, and the like. In addition, funds 12 are also entrusted to a closing agent 20 for distribution to designated recipients.

As described above, there are two basic categories of recipients: recipient vendors 22, who are paid regardless of whether the settlement is carried through to completion, and recipient paid-upon-settlement companies 24, who are paid only when the settlement has been completed. Recipient paid-upon-settlement companies 24 typically also make payments to paid-upon-settlement company sub-recipients 28, typically employees, whose compensation is contingent upon the settlement being completed. In addition, recipient vendors 22 may also make payments to vendor sub 26. As mentioned above, paid-upon-settlement company sub-recipients and vendor sub-recipients are generically referred to herein as “sub-recipients.” Currently, a closing agent typically 20 makes payments to recipients 22 and 24 using checks. After receiving these checks, recipients 22 and 24 make payments owed to sub-recipients 26 and 28. The payments to sub-recipients 26 and 28 are typically made according to established pay schedules of the recipients 22 and 24. Thus, if a sub-recipient is an employee of a recipient, the sub-recipient may receive a payment in the form of an amount added to the employee's next paycheck. If an employee sub-recipient is paid once a month or every other week, the employee sub-recipient may have to wait several days or even weeks before receiving a payment, even though that payment may have been earned at the moment the closing was completed. For these and other reasons, it is desirable for the delay between settlement and disbursement of payments to recipients and sub-recipients to be compressed.

An aspect of the present invention provides systems and methods for reducing this delay to a matter of minutes, using existing payment systems for making on-line wire transfers or their equivalents. One such payment system is PayPal.com™, which currently services two million users of the on-line auction service eBay.com. One feature of the PayPal™ system is that a payee may receive payment of funds without having to disclose their bank account or bank ABA number. The payee needs only an e-mail address to open a PayPal™ account. PayPal™ operates as a combination bank and clearinghouse. Funds in a PayPal™ account are made available to a PayPal™ accountholder for withdrawal by using an automated teller machine (ATM). Alternatively, a payee may elect to receive funds from PayPal™ in the form of an electronic funds transfer (EFT) or paper check. PayPal™ generates revenue by charging a small fee to enable individual users, such as eBay sellers, to accept credit card payments from other users, such as eBay buyers. One feature of the PayPal™ system is that it provides sellers, such as eBay sellers, with the ability to promptly confirm payment at the close of a transaction, such as an eBay auction.

PayPal™ has not been acceptable in the real estate industry as a stand-alone solution to the problem of the delay between settlement and disbursement of fees to recipients and sub-recipients. One reason is that the PayPal™ system requires sub-recipients to disclose the amount of their payment to the closing agent. As described above, under current practice a closing agent typically makes a single lump-sum payment to each recipient, who then makes any required payments to sub Normally, a closing agent does not know the amount of the subsequent payments to sub-recipients.

Electronic funds transfers (EFTs) are also typically not used to disburse settlement funds for a number of reasons. EFTs can be cumbersome, and can be costly to the closing agent. In addition, in order to set up an EFT, a recipient would have to disclose possibly sensitive bank information. It should be noted that in certain situations, EFTs have been used to transfer funds from a closing agent to a particular vendor. For example, where a closing agent conducts a high volume of business with a vendor, the closing agent may agree to use an EFT as an accommodation to that vendor. However, even in this situation, the EFT is used only to transfer funds from the closing agent to the vendor, and is not used to transfer funds to the vendor's sub-recipients.

An aspect of the invention provides a system for using a payment system, such as PayPal™, to make payments to sub-recipients in a manner that shields the payment information from the closing agent. Thus, the delay between settlement and disbursement of closing funds to recipients and sub-recipients can be reduced to a matter of minutes, without disclosing sensitive information. The system is generally referred to herein as the “Speed Pay™” system.

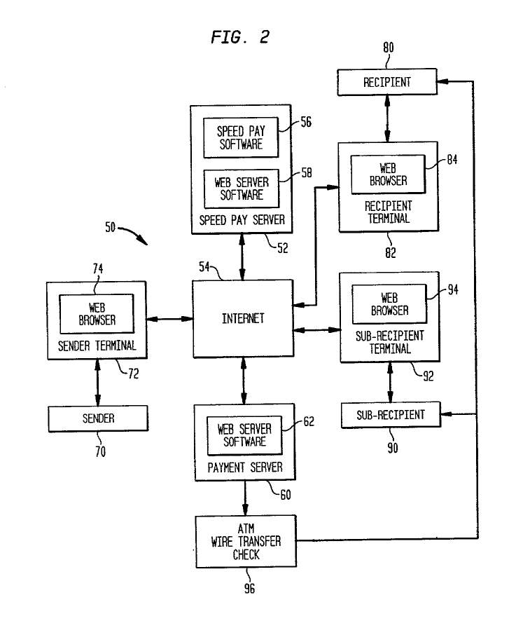

FIG. 2 shows a diagram of a Speed Pay™ system 50 according to an aspect of the present invention. The Speed Pay™ system 50 is administered by a Speed Pay™ server computer 52, which is connected to the Internet 54, and electronically receives inputs from, and provides outputs to, other computers connected to the Internet 54, as described below. It will be appreciated that it would be possible to implement the Speed Pay™ system 50 over other types of networks, including for example an organizational intranet behind a firewall. It should also be noted that although the Speed Pay™ server 52 is shown as a single unit in FIG. 2, it would also be possible to implement the server 52 as a plurality of computers and peripheral devices that are networked together.

The Speed Pay™ server computer 52 runs on a suitable operating system platform, such as Windows NT. A Speed Pay™ software module 56 is run by the Speed Pay™ server to perform the functions described below. This software module 56 may be implemented, by example, in the form of component object model (COM) objects. The Speed Pay™ server computer 52 further runs suitable web server software 58, that provides an interface between the Speed Pay™ software module 56 and the Internet 54. According to a further aspect of the invention, the Speed Pay™ software module 56 and the web server software 58 may be used to generate active server pages (ASPs) that are sent over the Internet for inputting and outputting data at remote terminals.

The Speed Pay™ server 52 works in conjunction with a payment server 60, such as the server for the PayPal™ system described above. The Speed Pay™ server 52 communicates with the payment server 60 over the Internet 54. The payment server 60 runs suitable web server software 62 to allow this communication to take place. As part of the Speed Pay™ system, the Speed Pay™ server 52 sends instructions, as described below, to the payment server 60 to make payments to a recipient 80 and a sub-recipient 90.

It should be noted that for the purposes of discussion, a single recipient 80 and sub-recipient 90 are illustrated in FIG. 2. However, it will be appreciated that the present invention is equally applicable to transactions including any number of recipients 80 and sub-recipients 82.

As shown in FIG. 2, a sender 70, a recipient 80, and a sub-recipient 90 are all connected to the Internet using, respectively, a sender terminal 72, a recipient terminal 82, and a sub-recipient terminal 92. Each terminal 72, 82, and 92 runs suitable web browser software 74, 84, and 94, such as Microsoft Internet Explorer or Netscape Navigator, that includes the capability of sending and receiving e-mail. For the purposes of the present description of the invention, the word “sender” is a general term that includes, for example, a closing agent. However, it will be appreciated that the Speed Pay™ system, as described herein, may be used in other contexts without departing from the spirit of the invention. As further shown in FIG. 2, the payment server 60 includes the capability of transferring funds to the recipient 80 and sub-recipient 90 using an ATM, electronic funds transfer, or check 96.

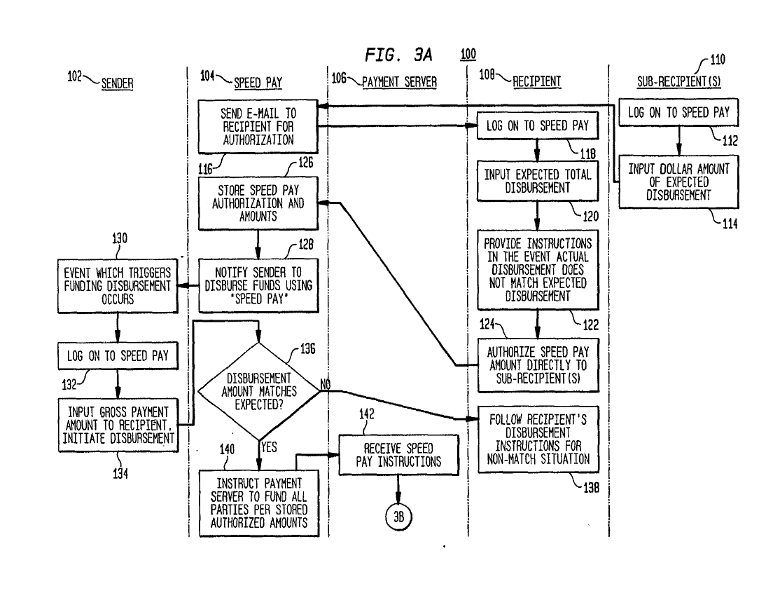

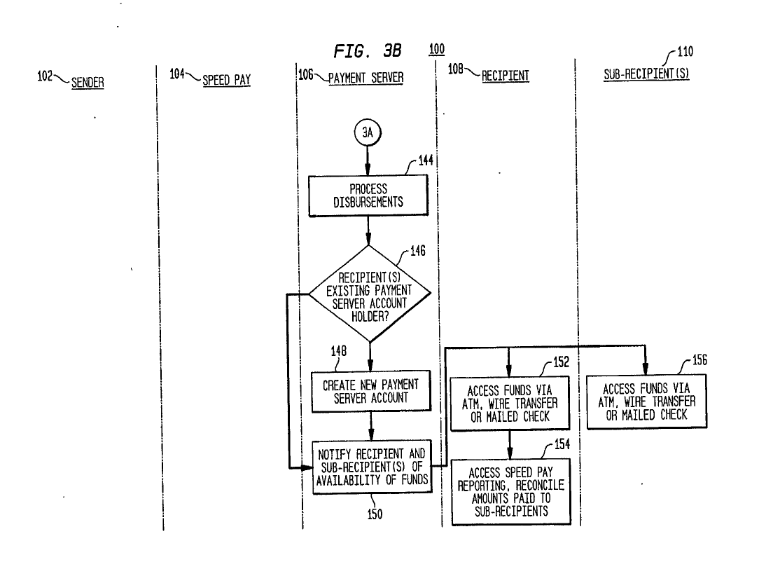

FIG. 3 shows a flowchart illustrating a payment method 100 according to a further aspect of the invention. As shown in the flowchart, actions are performed by: a sender 102, a Speed Pay™ server 104, a payment server 106, a recipient 108, and a sub-recipient 110. The sender 102, recipient 108, and sub-recipient 110 communicate with the Speed Pay™ server by using, respectively, a sender terminal, recipient terminal, and sub-recipient terminal, such as those illustrated in FIG. 2 and described above. Again, for the purposes of discussion, only a single recipient 108 and sub-recipient 110 are shown. However, it will be appreciated that the invention is equally applicable to transactions including any number of recipients 108 and sub-recipients 110.

In step 112, a sub-recipient 110 logs onto the Speed Pay™ server. For security purposes, the sub-recipient 110 may be provided with a unique user identification and password. In step 114, the sub-recipient 110 inputs the dollar amount of the expected disbursement to be paid to the sub-recipient 110 at settlement. In step 116, having received the dollar amount information inputted in step 114, the Speed Pay™ server 104 automatically sends an e-mail to the recipient 108 requesting authorization.

In step 118, the recipient 108 logs onto the Speed Pay™ server. Again, for security purposes, the recipient 108 may be provided with a unique user identification and password. In step 120, the recipient 108 inputs the expected total disbursement expected to be received by the recipient at settlement. The total disbursement amount includes the amount to be paid to the sub-recipient 110. In step 122, the recipient 108 provides instructions to be followed in the event that the actual disbursement at settlement does not match the expected disbursement. In step 124, the recipient 108 authorizes the amounts to be paid by the Speed Pay™ server 104 directly to the sub-recipient 110.

It should be noted that the ability of the recipient 108 to provide instructions in step 122 is a useful aspect of the present invention, as it is not uncommon for the actual disbursement at settlement not to match the amount of the disbursement expected by the recipient. It is contemplated that the instructions provided by the recipient may range from the relatively simple to the complex. For example, a recipient may provide an instruction that, if the amounts do not match, the Speed Pay™ system should not make any payments to the recipient and sub-recipient, pending an investigation by the recipient. Alternatively, the recipient may instruct the Speed Pay™ system to make a payment to the recipient for the full amount of the actual disbursement, without making any payments to sub-recipients. Further, a recipient may give conditional instructions to the Speed Pay™ system. For example, a recipient may instruct the Speed Pay™ system to make payments to the recipient and sub-recipient if the actual disbursement is greater than the expected disbursement, but not to make payments if the actual disbursement is less than the expected disbursement. A recipient may also instruct the Speed Pay™ system, in the event of a shortfall between the actual disbursement and the expected disbursement, to apportion the shortfall between the amounts paid to the recipient and the sub-recipient according to a predetermined formula.

In step 126, the authorization and amounts provided by the recipient in steps 118 through 124 are stored. In step 128, the closing agent or other sender 102 is notified by e-mail or other suitable form of communication to disburse funds using the Speed Pay™ system. In step 130, the event that triggers the disbursement of funds occurs. In a real estate transaction, the triggering event would typically be the closing of the transaction at settlement. In step 132, the closing agent or other sender 102 logs onto the Speed Pay™ server. In step 134, the closing agent or other sender 102 inputs the gross payment amount to the recipient, and initiates the disbursement of settlement funds into the Speed Pay™ system for payment to recipients and sub-recipients.

In step 136, the Speed Pay™ server 104 determines whether the amount of the disbursement received from the sender 102 in step 134 in respect of the recipient matches the amount inputted by the recipient in step 120. If it is determined that the two amounts do not match, then in step 138, the Speed Pay™ server 104 follows the instructions inputted by the recipient in step 122. If, however, in step 136 it is determined that the two amounts match, then in step 140, the Speed Pay™ server 104 instructs the payment server 106 to make direct payments to the recipient and sub-recipient in accordance with the stored, authorized amounts. These amounts include the amounts to be paid to sub-recipients 110 authorized in step 124. The amount to be paid to the recipient 108 is the total amount of the disbursement less any amounts to be paid to sub 110.

In step 142, the payment server 106 receives the instructions issued by the Speed Pay™ server 104 in step 140. In step 144, the payment server 106 processes the disbursements. In step 146, the payment server 106 determines whether the recipient 108 or sub-recipient 110 identified in the transaction are existing payment server accountholders. If not, then in step 148, a new payment server account is created for the each non-accountholder. If in step 146, it is determined that the recipient 108 and sub-recipient 110 are in fact existing payment server accountholders, then step 148 is skipped, and the payment server 106 proceeds directly to step 150.

In step 150, the payment server 106 notifies the recipient 108 and the sub 110 of the availability of funds. In step 152, the recipient 108 accesses funds using an ATM. Alternatively, the recipient 108 may request payment in the form of a wire transfer or a mailed paper check. In step 154, the recipient 108 may, as desired, access the Speed Pay™ server 104 to obtain a report. The report includes a statement indicating the amount of money paid directly to the sub 110. This statement can be used by the recipient to reconcile the amounts paid to sub-recipients and to perform other bookkeeping functions. In step 156, the sub-recipient 110 accesses funds using an ATM. Alternatively, the sub-recipient may request payment in the form of a wire transfer or mailed check.

It should be noted that the method described above may also be used in situations in which there is no sub-recipient 110. In those situations, steps 112, 114, 116, 124, and 156 would be omitted. Also, steps 146 through 150 would only be performed with respect to the recipient 108.

It should also be noted that the method described above may be modified to provide for withholding of taxes and other amounts normally withheld from a sub-recipient's paycheck, without departing from the spirit on the invention. One way of accomplishing this would be to calculate the amount of the sub-recipient portion of the expected total disbursement net of withholdings, whereby the amount paid to the recipient includes the withheld amounts. The recipient would then dispose of these withheld amounts in accordance with the recipient's established practice, or as otherwise desired.

From the above description, it will be seen that the Speed Pay™ system serves to shield the closing agent or other sender from information regarding how much of the total disbursement paid to a recipient is to be passed through to sub-recipients. As mentioned above, this information may be sensitive in certain situations. The sender only is aware of the amount of the total disbursement to the recipient. The recipient maintains control over the amounts to be paid to sub-recipients because, as described above, monies can only be paid to sub-recipients after those amounts have been specifically authorized by the recipient.

Thus, using the Speed Pay™ system, the amount of time required to make disbursements to recipients and sub-recipients can be reduced by days or even weeks to a matter of minutes. For example, the payment of recipients and sub-recipients can be handled as a step in the closing at the bank or attorney's office, using a computer with an Internet connection. This approach also advantageously spares the closing agent the task of having paper checks prepared and distributed.

While the foregoing description includes details which will enable those skilled in the art to practice the invention, it should be recognized that the description is illustrative in nature and that many modifications and variations thereof will be apparent to those skilled in the art having the benefit of these teachings. It is accordingly intended that the invention herein be defined solely by the claims appended hereto and that the claims be interpreted as broadly as permitted by the prior art.

1. A method for paying a recipient and a sub-recipient, comprising:
(a) electronically receiving and storing from a recipient an amount of an expected total disbursement, an amount of a sub-recipient portion of the expected total disbursement, and an authorization to pay the sub-recipient portion of the expected total disbursement directly to the sub-recipient;
(b) electronically receiving from a sender a gross disbursement for payment to the recipient;
(c) determining whether the amount of the gross disbursement received from the sender matches the amount of the total disbursement expected by the recipient; and
(d) if the amount of the gross disbursement received from the sender matches the amount of the total disbursement expected by the recipient:
instructing a payment server to make a direct payment to the recipient of the expected total disbursement, less any sub-recipient portions of the expected total disbursement, and
instructing the payment server to make a direct payment to the sub-recipient of the sub-recipient portion of the expected total disbursement.

2. The method of claim 1, further including:
shielding the sender from information regarding the amount of any sub-recipient portions of the expected total disbursement.

3. The method of claim 1, further including the following step performed between steps (a) and (b):
notifying the sender to disburse funds.

4. The method of claim 1, wherein step (a) further includes:
receiving and storing instructions from the recipient to be followed if the gross disbursement amount received from the sender does not match the expected total disbursement amount received from the recipient.

5. The method of claim 4, wherein step (e) further includes:
if the amount of the gross disbursement received from the sender does not match the amount of the total disbursement expected by the recipient, following the stored instructions.

6. The method of claim 1, further including the following step performed prior to step (a):
receiving from the sub-recipient the amount of the sub-recipient portion of the expected total disbursement and sending the amount to the recipient for authorization.

7. The method of claim 1, wherein payment is made using an automated teller machine.

8. The method of claim 1, wherein payment is made using an electronic funds transfer.

9. The method of claim 1, wherein payment is made using a check.

10. The method of claim 1, further including the following step performed after step (d):
providing a report to the recipient indicating the amount of money paid directly to the sub-recipient.

11. The method of claim 1, wherein the amount of the sub-recipient portion of the expected total disbursement is calculated net of withholdings, whereby the amount paid to the recipient includes the withheld amounts.

12. A method for paying a recipient and a sub-recipient, comprising:
(a) using a server computer to electronically receive from a sub-recipient an amount of a sub-recipient portion of an expected total disbursement and sending the amount to a recipient for authorization;
(b) using the server computer to electronically receive and store from the recipient an amount of the expected total disbursement, instructions from the recipient to be followed if a gross disbursement amount received from the sender does not match the expected total disbursement amount received from the recipient, and an authorization to pay the sub-recipient portion of the expected total disbursement directly to the sub
(c) notifying the sender to disburse funds;
(d) receiving from the sender a gross disbursement for payment to the recipient;
(e) determining whether the amount of the gross disbursement received from the sender matches the amount of the total disbursement expected by the recipient;
(f) following the stored instructions, if the amount of the gross disbursement received from the sender does not match the amount of the total disbursement expected by the recipient; and
(g) if the amount of the gross disbursement received from the sender matches the amount of the total disbursement expected by the recipient:
instructing a payment server to make a direct payment to the recipient of the expected total disbursement, less any sub-recipient portions of the expected total disbursement, and
instructing the payment server to make a direct payment to the sub-recipient of the sub-recipient portion of the expected total disbursement.

13. The method of claim 12, further including:
shielding the sender from information regarding the amount of any sub-recipient portions of the expected total disbursement.

14. The method of claim 12, wherein payment is made using an automated teller machine.

15. The method of claim 12, wherein payment is made using an electronic funds transfer.

16. The method of claim 12, wherein payment is made using a check.

17. The method of claim 12, further including the following step performed after step (g):
providing a report to the recipient indicating the amount of money paid directly to the sub-recipient.

18. The method of claim 1, wherein the amount of the sub-recipient portion of the expected total disbursement is calculated net of withholdings, whereby the amount paid to the recipient includes the withheld amounts.

19. A system for paying a recipient and a sub-recipient, comprising:
a server computer;
a sender terminal, connected to the server computer, for receiving inputs from and providing outputs to a sender;
a recipient terminal, connected to the server computer, for receiving inputs from and providing outputs to a recipient;
a sub-recipient terminal, connected to the server computer, for receiving inputs from and providing outputs to a sub-recipient; and
a payment server, connected to the server computer, for making payments to the recipient and the sub-recipient, pursuant to instructions received from the server computer,
the server computer receiving and storing from the recipient terminal an amount of an expected total disbursement, an amount of a sub-recipient portion of the expected total disbursement, and an authorization to pay the sub-recipient portion of the expected total disbursement directly to the sub-recipient,
the server computer receiving from the sender terminal a gross disbursement for payment to the recipient, determining whether the amount of the gross disbursement received from the sender matches the amount of the total disbursement expected by the recipient, and if the amount of the gross disbursement received from the sender matches the amount of the total disbursement expected by the recipient, instructing the payment server to make a direct payment to the recipient of the expected total disbursement, less the amount of any sub-recipient portions of the expected total disbursement, and instructing the payment server to make a direct payment to the sub-recipient of the sub-recipient portion of the expected total disbursement.

20. The system of claim 19, wherein the server computer is connected to the sender terminal, the recipient terminal, the sub-recipient terminal, and the payment server using the Internet.

21. The system of claim 19, wherein payment is made using an automated teller machine.

22. The system of claim 19, wherein payment is made using an electronic funds transfer.

23. The system of claim 19, wherein payment is made by check.

24. A system for paying a recipient and a sub-recipient, comprising:
a server computer;
a sender terminal, connected to the server computer, for receiving inputs from and providing outputs to a sender;
a recipient terminal, connected to the server computer, for receiving inputs from and providing outputs to a recipient;
a sub-recipient terminal, connected to the server computer, for receiving inputs from and providing outputs to a sub-recipient; and
a payment server, connected to the server computer, for making payments to the recipient and the sub-recipient, pursuant to instructions received from the server computer,
the server computer electronically receiving from the sub-recipient an amount of a sub-recipient portion of an expected total disbursement and sending the amount to the recipient for authorization,
the server computer electronically receiving and storing from the recipient an amount of the expected total disbursement, instructions from the recipient to be followed if a gross disbursement amount received from the sender does not match the expected total disbursement amount received from the recipient, and an authorization to pay the sub-recipient portion of the expected total disbursement directly to the sub-recipient,
the server computer notifying the sender to disburse funds and receiving from the sender a gross disbursement for payment to the recipient,
the server computer determining whether the amount of the gross disbursement received from the sender matches the amount of the total disbursement expected by the recipient and following the stored instructions, if the amount of the gross disbursement received from the sender does not match the amount of the total disbursement expected by the recipient; and if the amount of the gross disbursement received from the sender matches the amount of the total disbursement expected by the recipient, instructing the payment server to make a direct payment to the recipient of the expected total disbursement, less any sub-recipient portions of the expected total disbursement, and instructing the payment server to make a direct payment to the sub-recipient of the sub-recipient portion of the expected total disbursement.
